(19) United States
(12) Patent Application Publication
(10) Pub. No.: US 2009/0051314 A1
(43) Pub. Date: Feb. 26, 2009

(54) SELF-POWERED MAGNETIC GENERATOR

(76) Inventor: Puthalath Koroth Raghuprasad, Odessa, TX (US)

Correspondence Address: DAVID L. KING, SR., 5131 N.E. COUNTY ROAD 340, HIGH SPRINGS, FL, 32643, US

(21) Appl. No.: 11/842,439

(22) Filed: Aug. 21, 2007

(51) Int. Cl. H02J 7/14

(52) U.S. Cl. 320/108

(57) ABSTRACT

A power generation apparatus 100 has a moving permanent magnet 10 having a north polarity (N) at a first end 11 and a south polarity (S) at an opposite second end 12; a pair of electromagnets 20,22 are positioned with one being in proximity to each end 11,12 of the moving permanent magnet 10. Each electromagnet 20, 22 has a coil 25, 26 wrapped around a central iron core 27, 28. When activated the electromagnets 20, 22 provide a repulsive force of the same polarity as the nearest respective end 11 or 12 of the permanent magnet 10. The apparatus 100 further has one or more switches 32, 33 for activating each electromagnet 20, 22 and a central coil 40 encircling the permanent magnet 10 and a battery 50 connected to the central coil 40. Within the central core 40 the permanent magnet 10 is moving repeatedly toward each electromagnet 20 and 22 and as the N or S end of the magnet 10 approaches the electromagnet 20 or 22 of the same polarity the one or more switches 32, 33 turns the closest electromagnetic coil 25 or 26 on creating a repulsive electromagnetic field pushing the magnet 10 in an opposite direction towards the opposite electromagnet 20 or 22. These movements also switch power off of the one electromagnet 20 or 22 and thereafter switching the power on of the opposite electromagnet 20 or 22 creating a repulsive magnetic field to push the magnet 10 in a returning opposite direction. Each movement of the magnet 10 generates an electric current in the central coil 40 to power a light 30 used to activate the switches 32, 33 and to charge the battery 50 while any excess electricity generated can be used to power other devices.

### TECHNICAL FIELD

The present invention relates to an apparatus that generates an electric current through a coil to power or charge a battery using a moving permanent magnet and electromagnetic coils. Power generation is self sufficient i.e. no external power sources are needed.

### BACKGROUND OF THE INVENTION

The ability to generate an electric current by passing a magnet through a coil of electrically conductive wires is well known, and commonly referred as the Michael Faraday experiment.

The use of wires wound around a rotating bank of magnets is a common practice in the manufacture of electric motors and electric power generators.

It has long been a goal to use naturally occurring mechanical power to generate electricity. Hydraulic generation of power uses water flows to turn turbines; wave's motion has been suggested to generate electricity; new wind driven propellers are now making electricity and solar energy can be captured and converted to electric energy by using solar panels.

All of these devices convert an external physical force or energy into electricity. The biggest problem with such devices is the source of energy is not always constant. Water flows, wind and solar energy often times are not predictable and in the case of solar power it is not available during the night.

It is therefore an objective to develop electricity from a source that is relatively constant or at least predictable.

It is a further object to create a device that can generate electricity with very few losses in efficiency while having no adverse effects on the surrounding environment.

The following described invention uses magnetic force field to create motion and converts physical motion into electricity to generate a power supply.

### SUMMARY OF THE INVENTION

A power generation apparatus has a moving permanent magnet having a north polarity at a first end and a south polarity at an opposite second end; a pair of electromagnets are positioned with one being in proximity to each end of the moving permanent magnet. Each electromagnet has a coil wrapped around a central iron core. When activated the electromagnets provide a repulsive force of the same polarity as the nearest respective end of the permanent magnet. The apparatus further has one or more switches for activating each electromagnet and a central coil encircling the permanent magnet and a battery connected to the central coil. Within the central core the permanent magnet is moving repeatedly toward each electromagnet and as the N or S end of the magnet approaches the electromagnet of the same polarity the one or more switches turns the closest electromagnetic coil on creating a repulsive electromagnetic field pushing the magnet in an opposite direction towards the opposite electromagnet. These movements also switch power off of the one electromagnet and thereafter switching the power on of the opposite electromagnet creating a repulsive magnetic field to push the magnet in a returning opposite direction. Each movement of the magnet generates an electric current in the central coil to power a light and to charge the battery while any excess electricity generated can be used to power other devices.

The power generation apparatus may further include a means for activating the switches. Preferably the means for activating the switches is a light source. Each switch is activated by illumination from a light source and switched off by blockage or interruption of the light source. When the switch is open the electromagnetic field of the corresponding side of the electromagnet coil will be turned on. Preferably there is a switch for each electromagnet. However, each switch may be activated by a single light source. In order to provide a way for the light to pass from the light source to the switch, a cutout slit or slot can be provided in the magnet such that the light can pass from one side of the magnet to the switch on the opposite side of the magnet as the magnet is moving. Preferably the light source is an LED (in order to reduce power draw), laser or polarized light source or any defined wavelength of light. It may be desirable to isolate the switches from any ambient light or to have the switches respond to only polarized light or a predetermined wavelength. The permanent magnet preferably is attached or suspended on a swinging pendulum device. In one embodiment, the central coil has a large diameter with the top portion extending near to the pivot point and encircling most of the pendulum device up to an area in close proximity to the pivot point wherein the coil is indented slightly at this location to provide a space to allow the pivot device to swing freely without it impacting the coil. This space is intended to be small which allows more turns of the central coil which has a direct impact on the amount of power generated. In this way the moving magnet can swing widely over a greater distance without interference with the central core.

In order for the light source to transmit light to the switch, in an on/off action, it can be placed inside the coil and made very small not to interfere with the ability to generate electricity or outside the central coil. Also the central coil can be completely wound except at the top where a small space can be provided to allow the pendulum to swing.

Also preferably the permanent magnet can be slightly arcuately shaped so that it matches the corresponding path of the pendulum such that both ends at the north and south poles are slightly curved upwardly. Also the ends of the permanent magnet can be made heavier than the center portion of the magnet. Thus, as the magnet swings, the magnet at each end is tilted slightly upward into the coil and as the repulsive force occurs the magnet is then helped along by the force of gravity towards the opposite end wherein the process is repeated and the curved magnet is then swinging repeatedly back and forth inside the central coil generating an electric current to charge the battery.

In another embodiment, the entire system will be enclosed in a vacuum and this will help reduce friction and inertia dramatically. Alternatively, this device can be used in space in the absence of gravity wherein the permanent magnet and all of the swinging mechanisms are pivotally fixed or fixed within a housing such that the movement repeating back and forth can be created and repeated in such a zero gravity environment. The magnet simply relies on the repulsive magnetic forces to provide movement and power generation. It is believed that this method of charging a battery can be used in combination with other devices such as solar or wind to provide a means to constantly generate electricity to assist as a supply source for electricity. The objective is to use a minimal amount of electromagnetic force at each electromagnet requiring minimal use of electricity and that the light source should be of minimal electricity consumption such that the power generated exceeds the amount of energy consumed in such a fashion that the battery can be charged or create excess electricity for other purposes. It is understood that frictional losses and other losses can be accumulated such that in the end the device will need to have the battery recharged at some period. However, the expectation of battery charging is such that the inventor anticipates the battery can provide many times the normal amount of time to provide a constant working of the power generation apparatus.

It is anticipated that the electricity generated in the central core will itself help re-magnetize the moving permanent magnet. This will eliminate the need to replace or re-magnetize the magnet at required intervals. This continuous process of re-magnetizing eliminates the interruption of the generation of electricity.

### BRIEF DESCRIPTION OF THE DRAWINGS

FIG. 1 is a plan view showing the apparatus according to the present invention is shown. FIG. 1A is an enlarged view of the pivot point portion of the apparatus of FIG. 1

FIG. 2 shows the first embodiment of FIG. 1 wherein the magnet is being moved into proximity of first end coil with the dashed line showing the path of the bar magnet moving into this direction.

FIG. 3 shows the bar magnet being moved to the opposite end coil.

FIG. 4 is a top view of the apparatus

FIG. 5A is a top view of the power generation apparatus with the pendulum device and a portion of the central coil removed exposing and showing the light source and the switches, the light source being positioned transmitting light toward the switch in order to activate one of the coils.

FIG. 5B is a second top view similar to FIG. 5A wherein the opposite switch is activated by the light source as the magnet moves in the opposite direction wherein the light passes through a slot in the bar magnet.

### DETAILED DESCRIPTION OF THE INVENTION

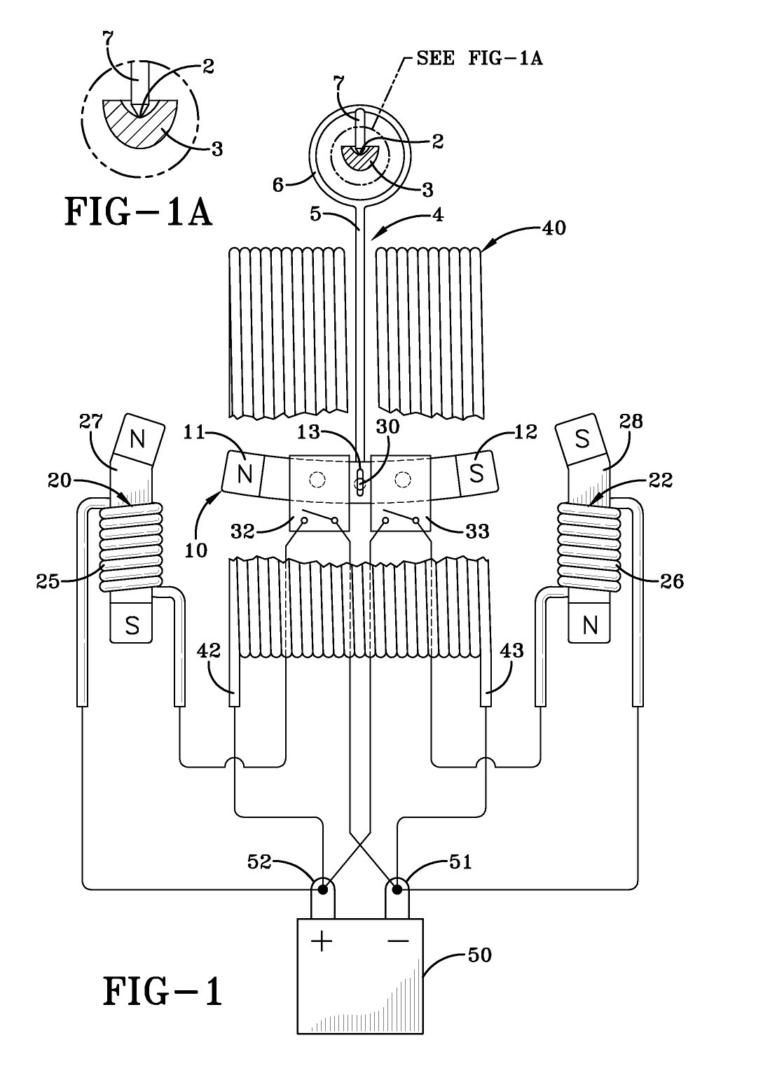

A power generation apparatus 100 is illustrated in FIG. 1; as shown the power generation apparatus 100 has a permanent magnet 10 suspended from a pivoting fulcrum point 2. Extending from the pivoting fulcrum point 2, as shown, a line or rod 5 preferably shaped as a flat plate in the direction of swing suspends the magnet 10. At the top of the rod 5 the end 6 is placed on an oblong cup shaped support surface 3 aligned lengthwise with the pendulum swing. The end 6 includes a rounded needle point 7 at the pivot point 2 to minimize the resistance of the apparatus 100 as it swings from left to right in a slightly arcuate manner as is common with pendulum devices 4. The support surface 3 being cup shaped keeps the needle point 7 from falling off the support as the pendulum swings. In order to avoid random oscillations it might be advantageous to have an oblong cup shape of the support surface 3 extending side to side preferably as shown in FIG. 1A in the direction of the pendulum 4 swing. In order to reduce wear on the needle tip 7 and the contact surface 3 both can be ceramic coated or made of similarly suitable hard tough durable material which also reduces frictional and efficiency losses of the generator apparatus 100. The permanent magnet 10 has a north pole (N) or a south pole (S) at opposite ends 11 and 12, the polarity of the magnet 10 ensures that the magnet 10 can react with electromagnets 20, 22 as illustrated. Each coil 25, 26 of the electromagnet 20, 22 is wound to create a polarity similar to one end of the magnet 10 and as the magnet 10 approaches an electromagnet 20 or 22 in its pendulum action a light source 30 passes through the magnet 10 tangentially preferably in a slot or cut opening 13 such that a switch 32 is activated that initiates one of the electromagnetic coils 25 or 26 of the electromagnets 20,22 to provide a magnetic field repulsive force of the same polarity (N) or (S) as the approaching end 11 or 12 of the magnet 10.

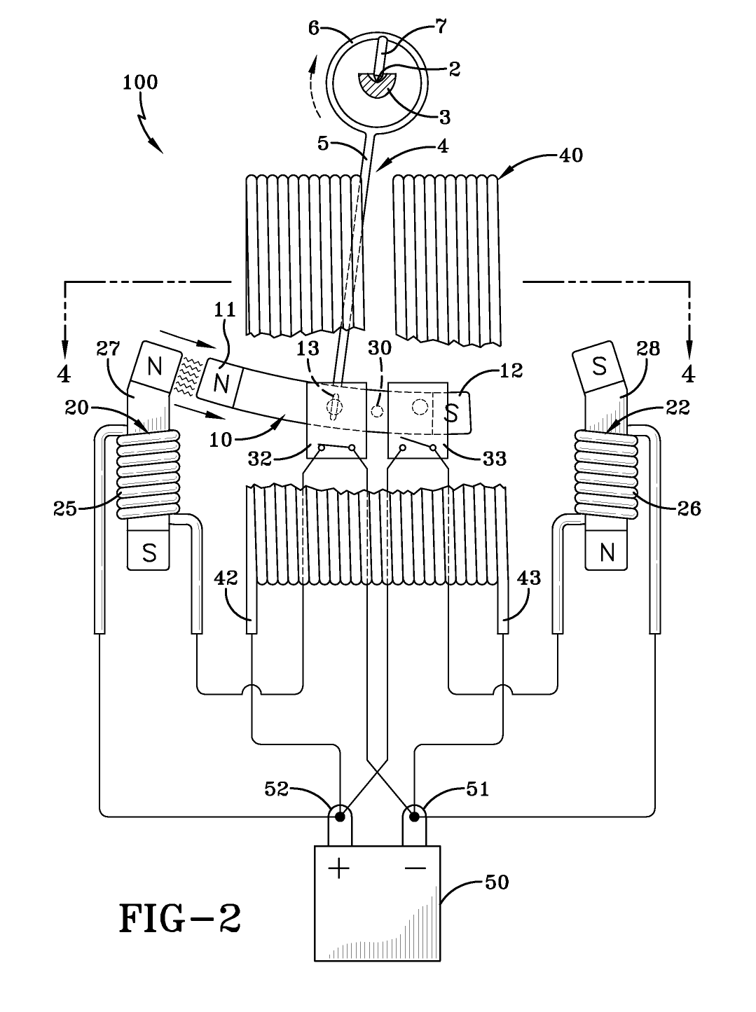

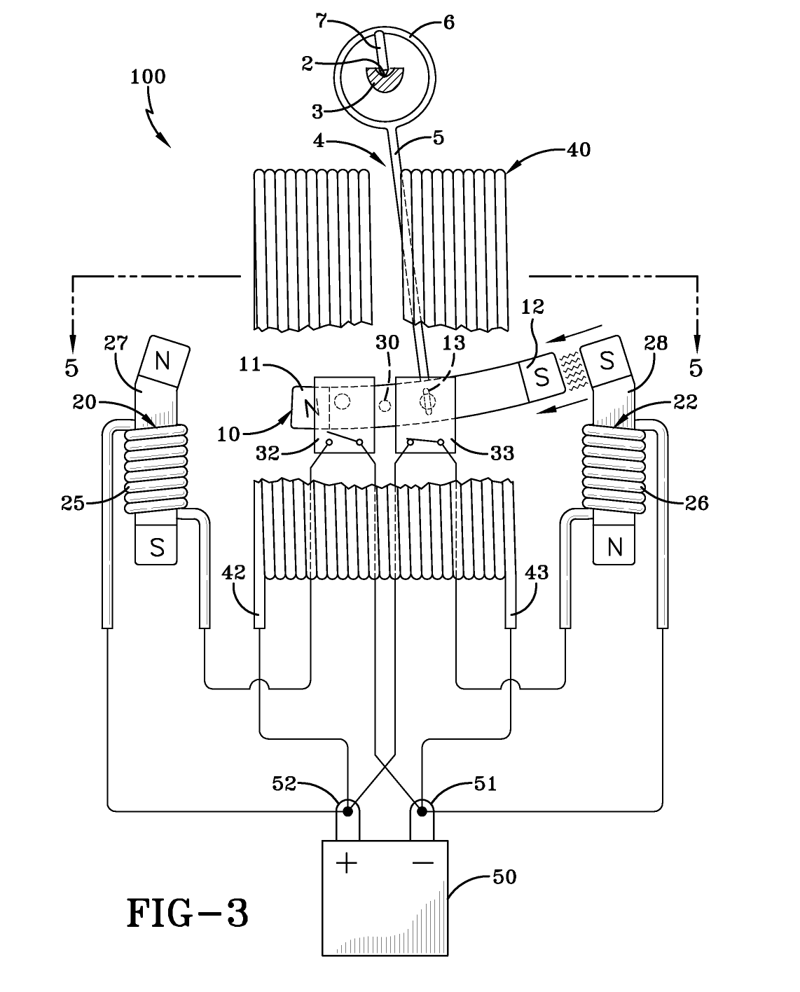

As shown in FIG. 2, as the north pole (N) approaches the left hand side first electromagnet 20 of similar polarity (N) the switch 32 turns on in response to the light source 30 and the bar magnet 10 is pushed back with the repulsive magnetic force sending the magnet 10 in the opposite direction. As the magnet 10 passes in front of the light source 30, the slot 13 is moved to the opposite side and passes the second switch 33 which is activated, the first switch 32 shuts off the electromagnet 20 as the slot 13 passes back through to the opposite side before the second switch 33 is turned on by the light illuminating light source 30. The second switch 33 opens such that the second electromagnet 22 is activated creating a magnetic field on the right hand side of a south polarity (S) that repulsively pushes the south pole (S) of the permanent magnet 10 back in the opposite direction, as shown in FIG. 3. This process is repeated continuously with movement of the magnet 10 left to right as illustrated. A crucial element of this switching mechanism is the placement of the location of the switches 32, 33. A fine balance must be found between the distance between the switches 32,333 and the swing of the moving permanent magnet 10, such that a critical angle of inclination of the light beam 31 and the duration of the beam 31 falling on the switches 32,33, the objective being to limit the time the electromagnet 20 or 22 is activated. As the magnet 10 moves between these two electromagnets 20, 22 due to the repulsive magnetic fields generated, the magnet 10 is moved within a larger central coil 40. The central coil 40, as illustrated, is connected to a battery 50, this battery 50 accepts the electric current produced by the movement of the magnet 10 within the central coil 40 and charges the battery 50. The battery 50 in turn provides a power source for the light 30 and the two electromagnets 20, 22. In addition, preferably the battery 50 is receiving a larger charge of electricity than it is consuming in such a fashion that the apparatus 100 generates electric power to be stored in the battery 50 as illustrated. As such the device 100 can continue to operate repeatedly in a fashion to charge batteries and to provide a source of electricity.

In order to facilitate the movement along the arcuate path it is preferable that the bar magnet 10 be curved slightly to mimic the curvature of the path of the pendulum and more heavily weighted at each end 11, 12. As shown the ends 11, 12 are square and flat, alternatively the ends can be aerodynamically rounded and the overall cross-section of the magnet can be made thin to reduce air drag.

The principle behind this invention is that the permanent magnet 10 being suspended within a coil 40 wherein the magnet moves like a pendulum between the electromagnets 20, 22 wherein the movement to and fro creates a current or flow of electricity in the central coil 40 that is used to recharge the battery 50 that supplies the power to run the switches 32, 33 and light source 30 to alternatively sending power to the stationary electromagnets coils 25, 26 to magnetize the electromagnets 20, 22. The objective is to create a fine balance between the electromagnets 20, 22 and the permanent magnet 10 such that only minimal amount of electromagnetic field force is required to send the pendulum 4 with the suspended magnet 10 in the opposite moving direction by using a minimal amount of electricity to activate the electromagnets 20, 22 and requiring that the electromagnets 20, 22 are only on for a very short and precise time as the magnet 10 approaches from the left or the right. One adaptation that might help in this endeavor in magnet 10 is to make the magnet thin to optimize weight and inertia. Preferably the light source 30, as shown, is an LED, laser or polarized light source or a light of a defined wavelength which uses a minimal amount of power. While this light source 30 can be left on continuously, it is important to note that the electromagnets 20, 22 are only operational over a short duration of time as the bar magnet 10 approaches them. Once approached, the repulsive force sends the magnet 10 in the opposite direction and the switches 32, 33 immediately shut the electromagnet 20 or 22 off until the other electromagnet 20 or 22 is activated. As such under normal operation only the light source 30 consumes power on a continuous basis. As noted once the motion of the magnet 10 is started, by simply moving the permanent bar magnet 10 laterally until it reaches a critical position, a beam of light 31 from the source 30 passes through the slot 13 impinging one of the light sensitive switches 32 or 33 and it turns on the respective electromagnets 20, 22. The polarity (N) or (S) of the magnet 10 at ends 11 or 12 is the same as that as the end of the electromagnets 20 or 22 and this repels the bar magnet 10 pushing it to the other side. This reciprocal serial action will repel the other end (N) or (S) of the bar magnet 10 pushing it back and thus the motion is continuously repeated. If the entire apparatus 100 is enclosed in an air tight chamber and a vacuum is established, this will help reduce frictional losses and thus the demand for power. Alternatively the apparatus 100 can be contained in a system used in a zero gravity environment wherein the apparatus can generate power in space if needed such as on the international space station. The movement of the magnet 10 back and forth internally within the space station creates a small power generation system that will enable the apparatus 100 to generate power in the absence of solar panels. These are beneficial in that they can be more readily protected and the apparatus can create a sufficient amount of power to help either supplement or provide internal power generation with a minimal consumption of energy. The working principles of the apparatus 100 are thus shown in FIGS. 2-5B wherein the apparatus 100 is shown in motion on the left side and right side of the pendulum swing, similarly the top view shows the light source 30 passing a beam of light 31 to one of the switches 32, 33 and then to the opposite switch 32, 33 as illustrated.

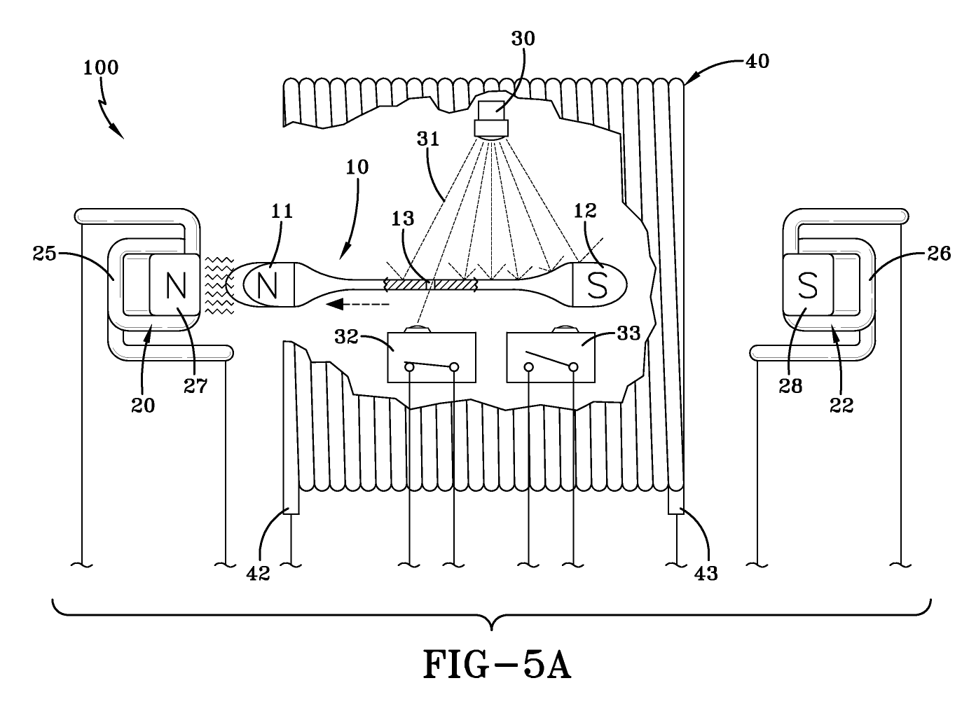

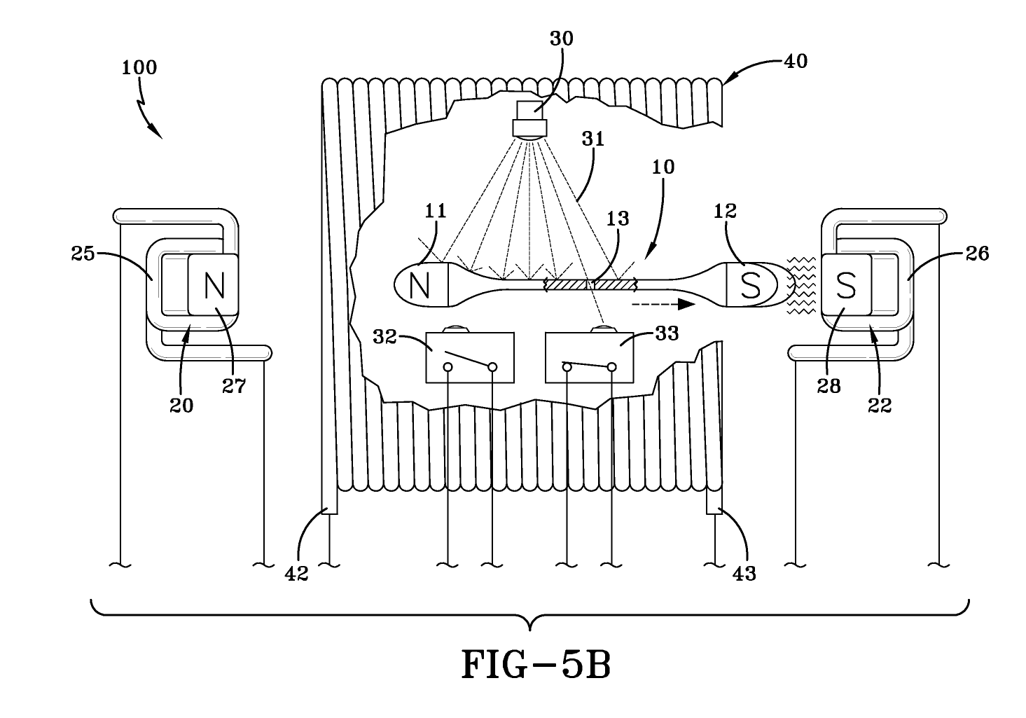

As shown the coils 41 of the central coil 40 are wound in a right hand direction or counterclockwise so that the permanent magnet 10 is continuously re-magnetized. If the coil 40 is wound in the wrong direction, there is even a chance of de-magnetizing the permanent magnet 10 impeding its free swinging as a pendulum. The ends 42, 43 of the coil 40 are appropriately connected to the battery 50; the right hand side connected to the negative terminal 51 and the left hand side being connected to the positive terminal 52 of the battery 50 in such a way to create a transfer of electricity. The electromagnets 20, 22 are similarly connected electrically to the battery 50 as is the light source 30 and switches 32, 33 to complete an electric circuit of the apparatus 100, as illustrated in FIGS. 5A and 5B.

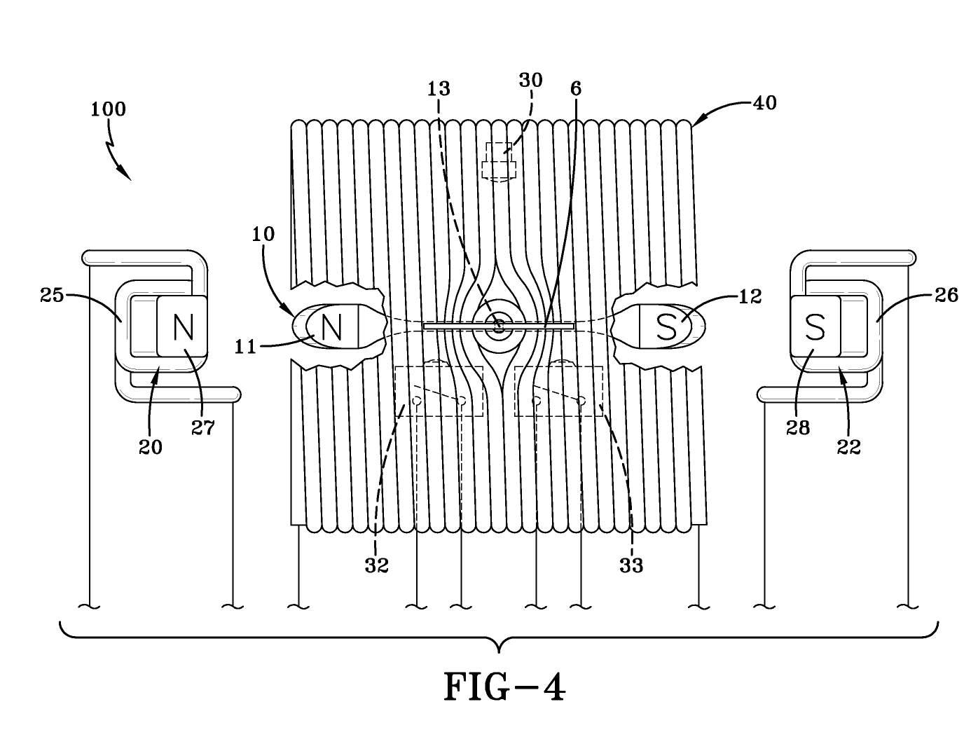

The coil 25 of the electromagnet 20 closest to the north pole (N) of the bar magnet 10 is wound in a similar counterclockwise direction, creating a north polarity at that end of the electromagnet 20 whereas the opposite coil 26 of electromagnet 22 is wound in an opposite direction or clockwise to create a south polarity (S) at the end of electromagnet 22 near the south end of the bar magnet 10 as illustrated in FIGS. 4,5A and 5B.

Depending on the size of the apparatus 100, the motion of the bar magnet 10 can be in a slow action similar to a clock mechanism wherein the bar magnet 10 can deliver the slow action using a relatively large arc or swing of the pendulum 4. Additionally an electrical transformer and rectifiers (not illustrated) can be placed in between the ends of the coil 40 and the battery 50 to control the voltages and convert currents generated from AC to DC and vice versa if so desired.

To increase the power you can increase the size of the bar magnet 10 and the number of windings in the central coil 40. In any event, the objective is to increase the amount of electricity generated by the movement of the bar magnet 10 within the central coil 40 such that a true power generating apparatus 100, can be achieved.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

1. A power generating apparatus comprises:
a moving permanent magnet having a north polarity at a first end and a south polarity at the opposite second end;
a pair of electromagnets, each having a coil and a central core, one electromagnet being positioned in proximity to each end of the permanent magnet, when activated the electromagnets provide a repulsive force of the same polarity as the nearest respective end of the magnet;
one or more switches for activating each electromagnet;
a central coil encircling the permanent magnet; and
a battery connected to the central coil, and wherein the permanent magnet is moved repeatedly toward each electromagnet and as the N or S end of the magnet approaches the electromagnets of the same polarity the one or more switches turns on the closest electromagnet coil, creating a repulsive electromagnetic field pushing the magnet in an opposite direction towards the opposite electromagnet and switching the power off of the one electromagnet and thereafter switching the power on of the opposite electromagnet creating a repulsive magnetic field to push the magnet in a returning opposite direction, each movement of the magnet generating an electric current in the central coil to charge the battery.

2. The power generation apparatus of claim 1 further comprises:
a means for activating switches.

3. The power generation apparatus of claim 1 wherein the means for activating the switches is a light source, each switch being activated by illumination from the light source and closed by blockage of the light source.

4. The power generation apparatus of claim 3 wherein the permanent magnet includes an optical slit for allowing light to pass from one side of the magnet to a switch on the opposite side.

5. The power generation apparatus of claim 3 wherein the light source is an LED, laser, polarized light or any defined wavelength of light.

6. The power generation apparatus of claim 1 wherein the permanent magnet is attached to and suspended from a swinging pendulum device.

7. The power generation apparatus of claim 1 wherein the central core encircles most of the pendulum device up to an area in close proximity to a pivot point.

8. The power generation apparatus of claim 1 wherein the central coil has a large diameter with a top portion of the coil extending to near the pivot point.

9. The power generation apparatus of claim 6 wherein the permanent magnet is arcuately shaped complimentary to a portion of the path of the pendulum device.

10. The power generation apparatus of claim 6 wherein the ends of the permanent magnet are heavier than central portions of the magnet.

11. The power generation apparatus of claim 6 wherein the ends of the permanent magnet are aerodynamically rounded.

12. The power generation apparatus of claim 6 wherein the permanent magnet has a thin cross-sectional thickness.
